(19) United States
(12) Patent Application Publication
(10) Pub. No.: US 2020/0174142 A1
(43) Pub. Date: Jun. 4, 2020

(54) LINEAR FITTING OF MULTI-THRESHOLD COUNTING DATA

(71) Applicant: PURDUE RESEARCH FOUNDATION, West Lafayette, IN (US)

(72) Inventors: Garth Jason Simpson, West Lafayette, IN (US); Ryan Douglas Muir, West Lafayette, IN (US); Nicholas Roman Pogranichniy, West Lafayette, IN (US)

(73) Assignee: PURDUE RESEARCH FOUNDATION, West Lafayette, IN (US)

(21) Appl. No.: 16/209,938

(22) Filed: Dec. 4, 2018

(51) Int. Cl. G01T 1/24; G01T 1/36; G01T 1/17

(52) U.S. Cl. CPC G01T 1/24; G01T 1/17; G01T 1/36

(57) ABSTRACT

The present disclosure provides a system and method for efficiently mining multi-threshold measurements acquired using photon counting pixel-array detectors for spectral imaging and diffraction analyses. Images of X-ray intensity as a function of X-ray energy were recorded on a 6 megapixel X-ray photon counting array detector through linear fitting of the measured counts recorded as a function of counting threshold. An analytical model is disclosed for describing the probability density of detected voltage, utilizing fractional photon counting to account for edge/corner effects from voltage plumes that spread across multiple pixels. Three-parameter fits to the model were independently performed for each pixel in the array for X-ray scattering images acquired for 13.5 keV and 15.0 keV X-ray energies. From the established pixel responses, multi-threshold composite images produced from the sum of 13.5 keV and 15.0 keV data can be analytically separated to recover the monochromatic images through simple linear fitting.

### CROSS-REFERENCE TO RELATED APPLICATIONS

The present U.S. patent application is related to and claims the priority benefit of U.S. patent application Ser. No. 14/708,335, filed May 11, 2015 which further claims priority to U.S. Provisional Ser. No. 61/992,197, filed May 12, 2014, the contents of which are hereby incorporated by reference in its entirety into this disclosure.

### STATEMENT OF GOVERNMENT INTEREST

This invention was made with government support under DE-AC02-06CH11357 awarded by the Department of Energy, GM103401 awarded by the National Institutes of Health, and GM106484 awarded by the National Institutes of Health. The government has certain rights in the invention.

### TECHNICAL FIELD

The present disclosure generally relates to X-ray imaging, and in particular to a method for mining multi-threshold measurements acquired using photon counting pixel-array detectors for spectral imaging and diffraction analyses.

### BACKGROUND

This section introduces aspects that may help facilitate a belter understanding of the disclosure. Accordingly, these statements are to be read in this light and are not to be understood as admissions about what is or is not prior art.

Energy-selective X-ray imaging holds great promise at addressing major challenges in X-ray imaging and diffraction. Laue diffraction requires broad-bandwidth X-ray sources and energy assignments for each measured diffraction spot. While this assignment is currently performed by analysis of the total diffraction pattern, improvements in assignments could be enabled through independent measurements of X-ray energies. In materials analysis, the transmittance of X-rays through different materials may be highly sensitive to the X-ray wavelength, particularly at wavelengths close to spectral band-edges. Consequently, spectral X-ray imaging provides contrast intimately connected to composition for materials analysis and biomedical applications.

Particularly in imaging applications with massively parallel detection, multi-threshold photon counting strikes a reasonable cost-benefit balance between the technical requirements to record and store the raw sensor data and the inherent information content it provides. However, accurately relating the measured counts back to X-ray photon energy remains challenging. In most current systems, pixels do have adjustable thresholds, but the voltage peak height distribution is nontrivial due to several factors. These include pixel-to-pixel variance in performance, photon counting paralysis at high count rates, and the spread in the photoelectron plume over multiple pixels. Consequently, the simplest approach of setting a threshold to detect one and not the other X-ray photon energy may be subject to significant errors.

Given the many practical challenges historically associated with spectral X-ray imaging, there is an unmet need for improvements in spectral X-ray imaging.

### SUMMARY

In one aspect, the present invention is related to a method for achieving high dynamic range detection based on multi-threshold photon counting. The method involves the steps of acquiring a detector response, modeling the detector response to result in a modeled detector response, fitting the modeled detector response on a pixel-by-pixel basis to acquire a plurality of information for the detector response, generating composite images from the plurality of information for the detector response, and separating composite images into individual contributions from different X-ray energies by fast linear fitting. The detector response comprising counts detected upon absorption of photons by a sensor. Analytical expressions arc used for measured peak height distribution and implementation of fractional photon counting.

In another aspect, the present invention is related to a method for mining multi-threshold measurements acquired using photon counting pixel-array detectors for spectral imaging and diffraction analyses. The method involves the steps of modeling a Gaussian random noise per photon. The modeling is based on a plurality of parameters, including a plurality of pixels, an amount of charge sharing occurring between the plurality of pixels, and a point spread occurring between the plurality of pixels. Also involved is the step of determining a most likely number of observed photons, wherein a plurality of counts at each threshold and a number of expected signal distributions per photon are utilized to allow mining multi-threshold measurements acquired using photon counting pixel-array detectors for spectral imaging and diffraction analyses. The combination of the plurality of parameters describes a distribution of signal expected from any one of the plurality of photons or combinations of the plurality of photons.

In another aspect, a system for mining multi-threshold measurements acquired using photon counting pixel-array detectors for spectral imaging and diffraction analyses is disclosed. The system has a photon counting pixel-array detector and a computing device. The computing device is configured to receive input from the photon counting pixel-array detector. The computing device is configured to model random noise per photon.

### BRIEF DESCRIPTION OF DRAWINGS

FIG. 1 is a diagram illustrating the X-ray sensing mechanism of a pixel detector.

FIG. 2a is a probability density function of the amount of equivalent charge observed by a single pixel from a single 13.5 keV X-ray photon.

FIG. 2b is a complimentary CDF (cCDF) of the amount of equivalent charge observed by a single pixel from a single 13.5 keV X-ray photon.

FIG. 3 is a series of images of diffuse X-ray scattering of monochromic 13.5 keV and 15.0 keV from ice at several equivalent detector threshold levels from 7.5 keV to 21 keV; two representative pixels are chosen from each image stack for displaying in a plot along with their fit to the cCDF model.

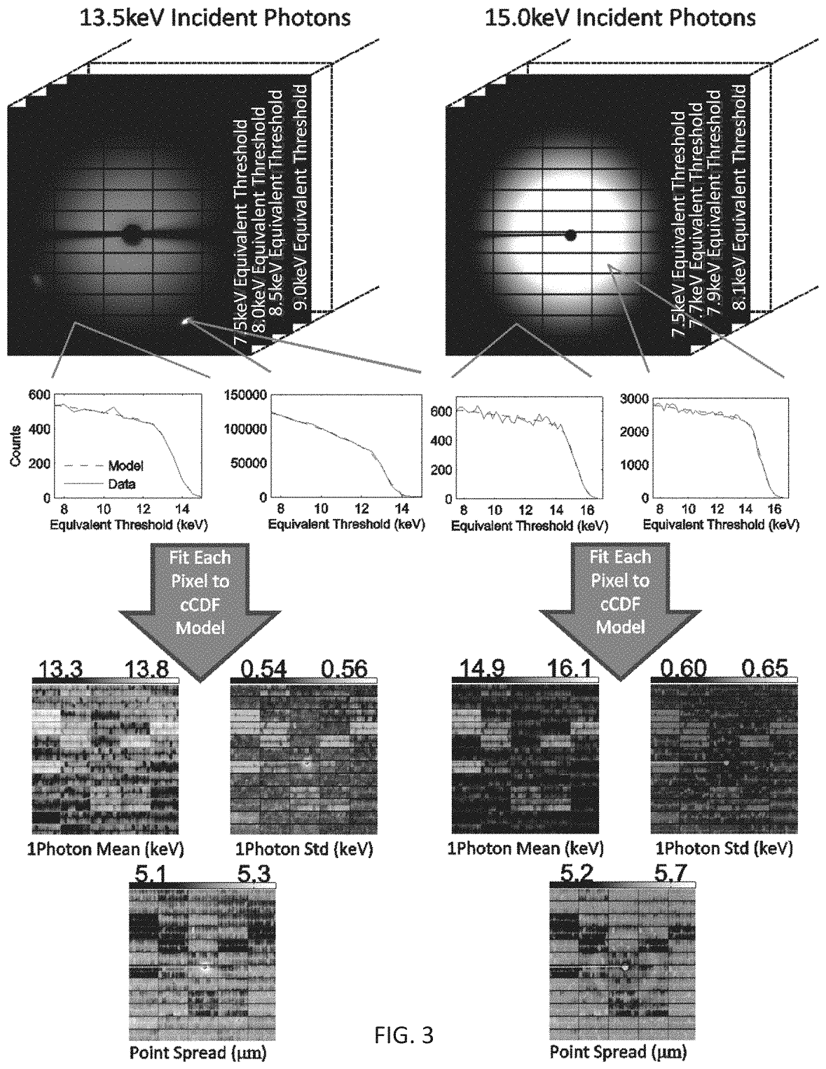

FIG. 4 is a series of images illustrating the experimental validation of the algorithm, which was performed by separating a composite image generated by summation of the counts acquired at 13.5 keV and 15.0 keV.

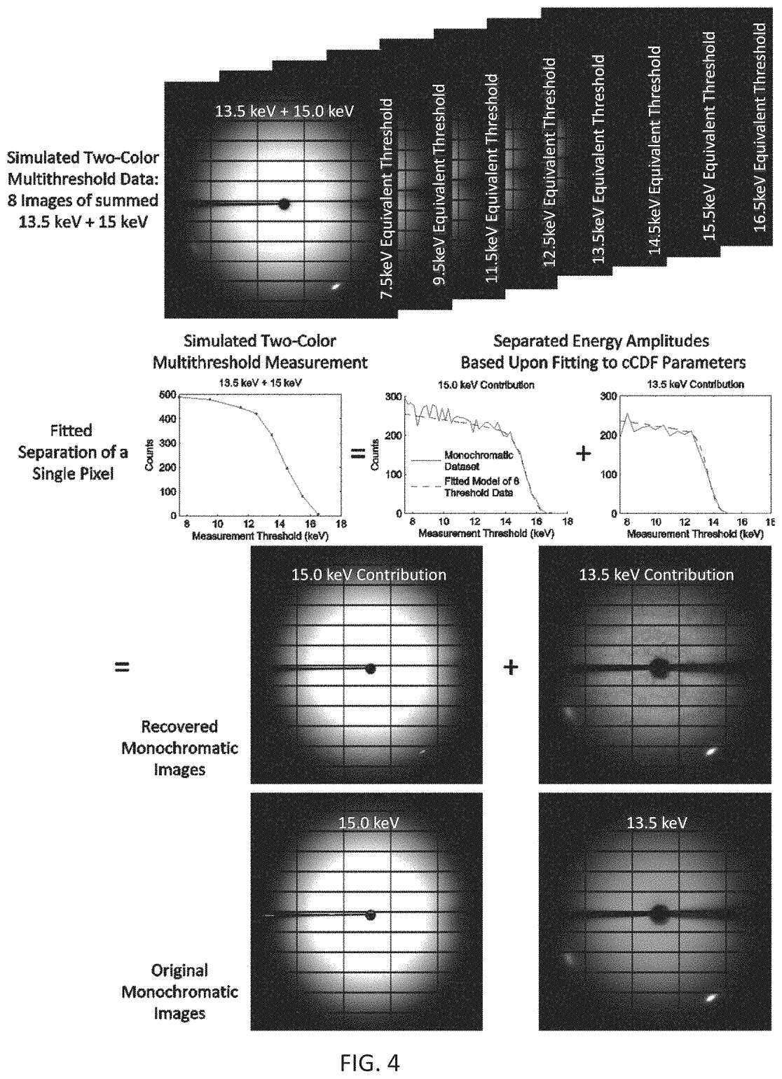

FIG. 5 is a diagram showing quantitative assessment of the error of the fitted values compared to the original monochromatic dataset.

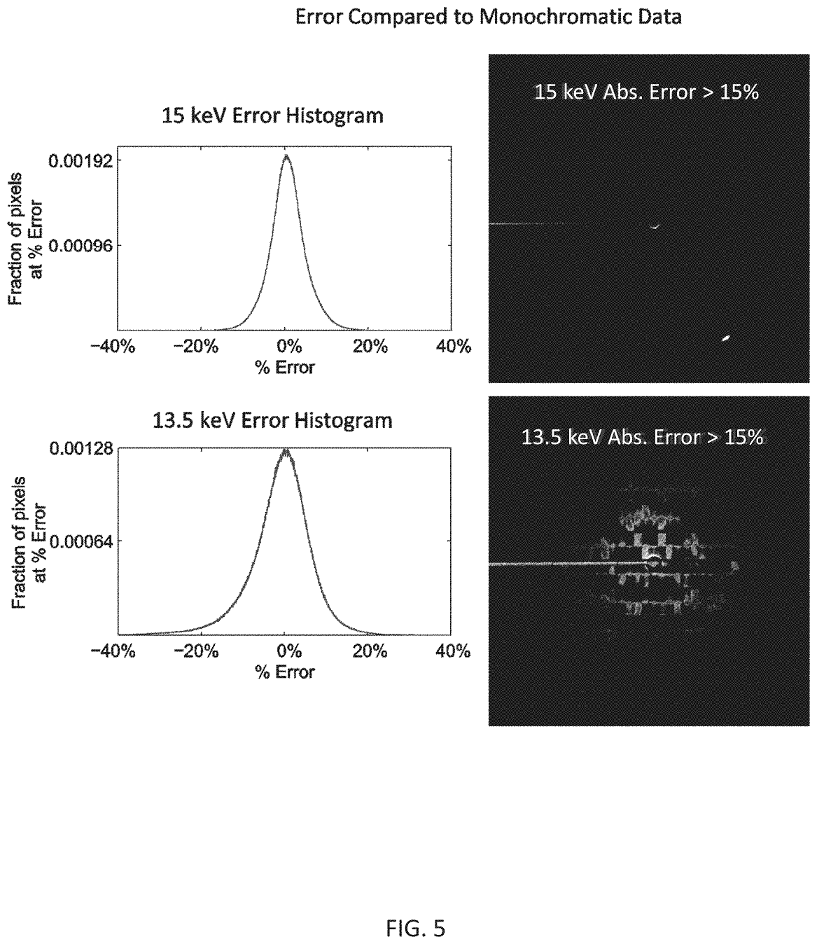

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In response to the unmet need, presented herein are a novel system and method for mining multi-threshold measurements acquired using photon counting pixel-array detectors for spectral imaging and diffraction analyses. As used herein, the terms pixel-array detector, pixel detector, and photon counting detector are used interchangeably. The system and method disclosed herein have the potential to be addressed in whole or in pan through the development of photon-counting array detectors, in which a programmable counting threshold provides a means of performing energy-specific imaging. In particular, a linear fitting approach is presented for spectral detection, in which the counts measured for many thresholds are combined in the analysis. The disclosed approach contributes to efforts for high dynamic range detection based on multi-threshold photon counting by taking advantage of the inherent statistics of the measurement. In the present disclosure, the detector response is modeled and fit on a pixel-by-pixel basis using analytical expressions for the measured peak height distribution und implementation of fractional photon counting. Once established, the information acquired from such modeling and fitting can in turn be used to separate composite images into individual contributions from different X-ray energies by fast linear fitting.

### Methods:

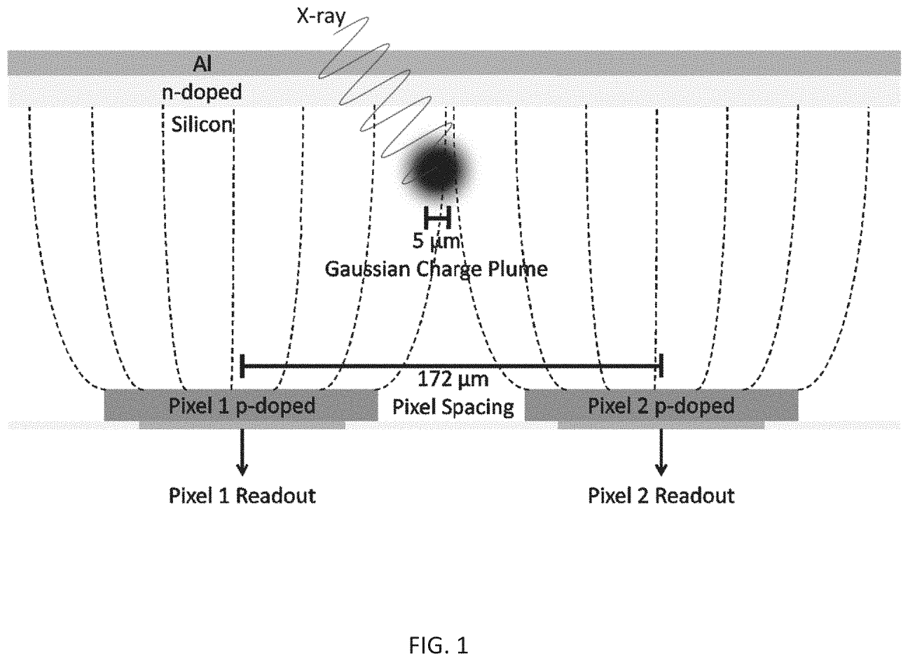

FIG. 1 is a model illustrating the X-ray sensing mechanism of a pixel detector. There is no dead space in the SiO₂ detector, causing the charge plume deposited by an X-ray photon to at times be fractionally detected across several charge-collecting pixels. Diffuse scattering of vitreous ice was measured with a pixel detector at several detector threshold levels. Five second exposure times were taken at each detector threshold for both 13.5 keV and 15 keV incident X-ray energies in a standard lattice (153 ns between X-ray pulses). Absolute detector voltage thresholds at each pixel were automatically calibrated through the pixel detectors automatic internal voltage trim system to maintain threshold accuracy. A low gain input amplifier setting was used for all measurements. The resulting internal voltage threshold levels are denoted herein as equivalent thresholds in units of keV, which describes the equivalent X-ray energy that would deposit this mean level of voltage. The 13.5 keV incident energy measurements were taken with equivalent threshold energies from 7.5 keV to 21.0 keV in steps of 0.5 keV with a detector distance of 0.700 m. The 15 keV incident energy measurements were taken on a later day with a new ice sample with equivalent threshold energies from 7.5 keV to 20.9 keV in steps of 0.2 keV with a detector distance of 1.000 m. In all cases, the incident photon flux was kept low enough to ensure a low probability of pulse pileup affecting counting results.

All data analysis was performed in MATLAB with custom software. Data files were read using the MATLAB macros package for cSAXS (Paul Scherrer Institute). ImageJ was also used to view data files using a plugin (CBF reader plugin, written by JLM).

### Results and Discussion:

An analytical model for the peak-height distribution as a function of threshold setting was developed based on the assumption of a 2D Gaussian spatial distribution in charge following X-ray absorption, which is consistent with previous models and simulations. The distribution has two contributions; one from X-rays in which the large majority of the plume lies within the area of a single detector pixel and another from plumes spreading over two or more pixels. In previous treatments, efforts to address the issue of charge distribution over multiple pixels have included setting the counting threshold equal to roughly half the mean voltage obtained from the plume centered on a pixel, such that only the pixel with the majority of charge would register a count. While reasonably successful in applications focused on detection alone, this approach becomes untenable for applications targeting energy discrimination, in which the mean voltage of a centered plume is also a variable in the analysis. Even in monochromatic X-ray detection, the half-maximum threshold approach may result in bias from corner effects, in which the plume is distributed over more than two pixels. As the dimensions of the array elements continue to be reduced in size, such effects are likely to become increasingly important.

The fraction of charge expected to be observed by a single pixel from any photon hitting on or near the pixel surface due to this plume effect may be described by the 2D surface integral across the x and y spatial coordinates of the silicon area above the pixel surface. For a pixel of width w, height h, and a boundary distance of consideration b for photons hitting near the pixel active area, this surface integral and its solution is given in Eq. (1):

$$F ( x , y ) = {{\int }^{b + w}}_{b} {{\int }^{b + h}}_{b} \frac{1}{2 {πσ}_{psf}^{2}} exp ( \frac{- {( x - {μ}_{x} )}^{2}}{2 {σ}_{psf}^{2}} ) exp ( \frac{- {( y - {μ}_{y} )}^{2}}{2 {σ}_{psf}^{2}} ) dxdy = \frac{1}{4} ( erf ( \frac{b + w - {μ}_{x}}{{σ}_{psf} \sqrt{2}} ) - erf ( \frac{b - {μ}_{x}}{{σ}_{psf} \sqrt{2}} ) ) ( erf ( \frac{b + h - {μ}_{y}}{{σ}_{psf} \sqrt{2}} ) - erf ( \frac{b - {μ}_{y}}{{σ}_{psf} \sqrt{2}} ) ) \qquad ( 1 )$$

The solution in Eq. 1 gives the fraction of charge F expected to be observed from a photon landing at point (μₓ,μ_{y}) with a Gaussian standard deviation plume of uncertainty of σ_{psf}. Assuming a uniform X-ray intensity field over the pixel surface from a monochromatic light source, a probability density function of fractional contributions may be obtained by Monte-Carlo simulation.

The peak height of the voltage transient observed by the threshold counting electronics from a 100% contribution of a single photon's charge is proportional to the energy of the incident X-ray photon, and has a normally distributed peak current/voltage. For fractional contributions of photon energy, the fractional contribution multiplicatively weights the photon's energy contribution. The resulting probability density function (PDF) of voltage peak heights is then described by a multiplication of random variables, where a random weight is applied to a voltage of normal uncertainty. The resulting overall probability density function for the amount of voltage observed by the counting electronics from any direct or proximal X-ray photon strike may be obtained by Monte-Carlo simulation or derived numerically using the product distribution integral. Generally stated, for Z=XY where X and Y are two independent random variables with PDFs ƒₓ and ƒ_{y}, the PDF of the product ƒ_{z} is given by Eq. (2).

$${f}_{z} ( z ) = {{\int }^{∞}}_{- ∞} {f}_{X} ( x ) {f}_{Y} ( \frac{z}{x} ) \frac{1}{\vert x \vert} dx \qquad ( 2 )$$

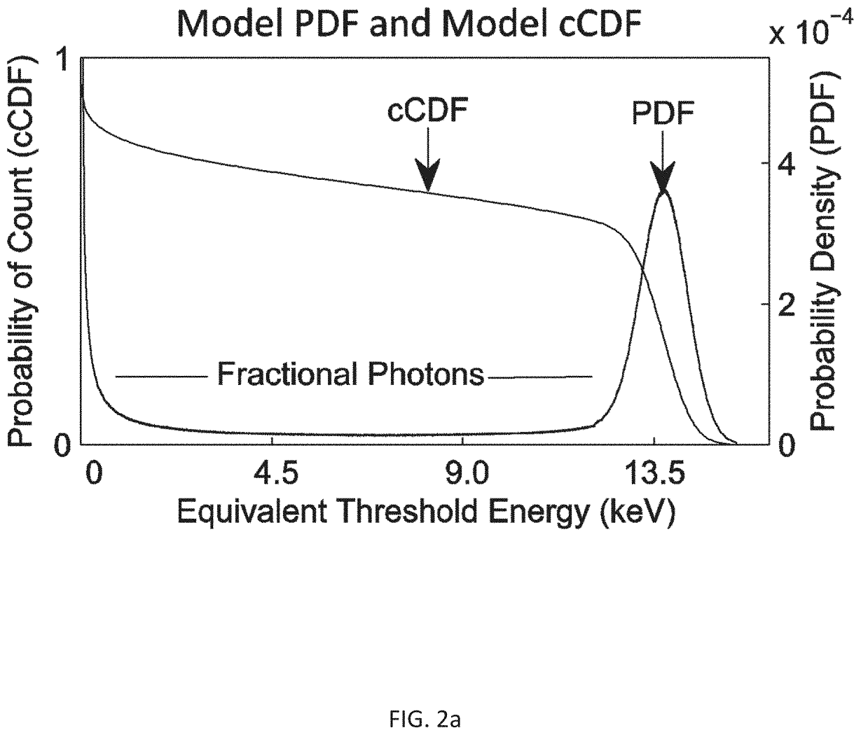

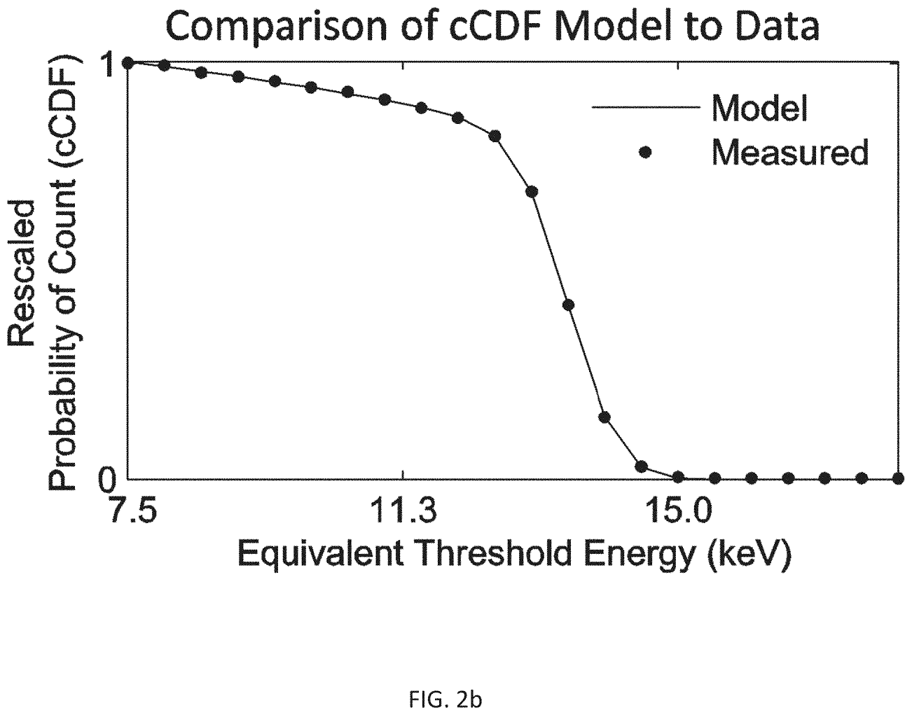

A representative peak height distribution is shown in FIGS. 2a and 2b, along with the complimentary cumulative density function (cCDF) corresponding to the anticipated measured probability of observing a count for a photon absorption event. FIG. 2a depicts the PDF and complimentary CDF (cCDF) of the amount of equivalent charge observed by a single pixel from a single 13.5 keV X-ray photon. Referring to FIG. 2a, the Gaussian hump on the right of the PDF represents collection of the full deposited charge following X-ray absorption, and all probabilities to the left of this hump represent fractional observations of the X-ray deposited charge plume. This distribution has a total of three parameters, with the photon energy standard deviation and photon energy mean describing the position and width of the Gaussian hump, and the size of the point spread affecting the depth of the trough to the left of the Gaussian hump. Referring to FIG. 2b, the cCDF was directly measured by the pixel detector from a 13.5 keV monochromatic source at many equivalent threshold energy levels from 7.5 keV to 21 keV. After averaging all pixel responses at every threshold, the data were fit to the model cCDF with excellent agreement. The model is also shown to be in good agreement with experimentally acquired data compared to the mean detector response averaged across all pixels for many measurement thresholds. The novel utility of this approach is that rather than satisfying the default intuition that each photon should be counted once as a full contribution, the unbiased intensity may be recovered by allowing for fractional photon counting, in which the fraction of the photon at that pixel is included in the measured PDF and cCDF. Further, signal contributions from photon strikes near pixel corners that were previously lost by setting the threshold to the equivalent of 50% of the incident photon energy may be now be properly accounted for by knowledge of the cCDF. The corresponding signal/noise increase will be particularly
6. Nik. S. J.; Meyer, J.; Watts, R., Optimal material discrimination using spectral x-ray imaging. Physics in Medicine and Biology 2011, 56 (18), 5969-5983.
7. Jakubek, J., Data processing and image reconstruction methods for pixel detectors. Nuclear Instruments & Methods in Physics Research Section α-Accelerators Spectrometers Detectors and Associated Equipment 2007, 576 (1). 223-234.
8. Roessl, E.; Proksa, R., K-edge imaging in x-ray computed tomography using multi-bin photon counting detectors. Physics in Medicine and Biology 2007, 52 (15). 4679-4696.
9. Fredenberg, E.; Lundqvist, M.; Cederstrom, B.; Aslund, M.; Danielsson, M., Energy resolution of a photon-counting silicon strip detector. Nuclear Instruments & Methods in Physics Research Section α-Accelerators Spectrometers Detectors and Associated Equipment 2010, 613 (1), 156-162.
10. Boone, J. M.; Shaber, G. S.; Tecotzky, M., Dual-Energy Mammography—A Detector Analysis

### Medical Physics 1990, 17 (4), 665-675.

11. Butler, A. P. H.; Anderson, N. G.; Tipples, R.; Cook, N.; Watts, R.; Meyer, J.; Bell, A. J.; Melzer, T. R.; Butler, P. H., Bio-medical X-ray imaging with spectroscopic pixel detectors. Nuclear Instruments & Methods in Physics Research Section α-Accelerators Spectrometers Detectors and Associated Equipment 2008, 591 (1), 141-146.
12. Procz, S.; Lubke, J.; Zwerger, A.; Mix, M.; Fiederle, M.; Optimization of Medipix-2 Threshold Masks for Spectroscopic X-Ray Imaging. Ieee Transactions on Nuclear Science 2009, 56 (4), 1795-1799.
13. Llopart, X.; Campbell, M.; Dinapoli, R.; Segundo, D. S.; Pemigotti, E., Medipix2: a 64-k pixel readout chip with 55 mu m square elements working in single photon counting mode. Ieee Transactions on Nuclear Science 2002, 49 (5), 2279-2283.
14. Ballabriga, R.; Campbell, M.; Heijne, E. H. M.; Llopart. X.; Tlustos, L., The medipix3 prototype, a pixel readout chip working in single photon counting mode with improved spectrometric performance. Ieee Transactions on Nuclear Science 2007, 54 (5), 1824-1829.
15. Broennimann, C.; Eikenberry, E. F.; Henrich, B.; Horisberger, R.; Huelsen, G.; Pohl, E.; Schmitt, B.; Schulze-Briese, C.; Suzuki, M.; Tomizaki, T.; Toyokawa, H.; Wagner, A., The PILATUS 1M detector. Journal of Synchrotron Radiation 2006, 13, 120-130.
6. Nik. S. J.; Meyer, J.; Watts, R., Optimal material discrimination using spectral x-ray imaging. Physics in Medicine and Biology 2011, 56 (18), 5969-5983.
7. Jakubek, J., Data processing and image reconstruction methods for pixel detectors. Nuclear Instruments & Methods in Physics Research Section α-Accelerators Spectrometers Detectors and Associated Equipment 2007, 576 (1). 223-234.
8. Roessl, E.; Proksa, R., K-edge imaging in x-ray computed tomography using multi-bin photon counting detectors. Physics in Medicine and Biology 2007, 52 (15). 4679-4696.
9. Fredenberg, E.; Lundqvist, M.; Cederstrom, B.; Aslund, M.; Danielsson, M., Energy resolution of a photon-counting silicon strip detector. Nuclear Instruments & Methods in Physics Research Section α-Accelerators Spectrometers Detectors and Associated Equipment 2010, 613 (1), 156-162.
10. Boone, J. M.; Shaber, G. S.; Tecotzky, M., Dual-Energy Mammography—A Detector Analysis

### Medical Physics 1990, 17 (4), 665-675.

11. Butler, A. P. H.; Anderson, N. G.; Tipples, R.; Cook, N.; Watts, R.; Meyer, J.; Bell, A. J.; Melzer, T. R.; Butler, P. H., Bio-medical X-ray imaging with spectroscopic pixel detectors. Nuclear Instruments & Methods in Physics Research Section α-Accelerators Spectrometers Detectors and Associated Equipment 2008, 591 (1), 141-146.
12. Procz, S.; Lubke, J.; Zwerger, A.; Mix, M.; Fiederle, M.; Optimization of Medipix-2 Threshold Masks for Spectroscopic X-Ray Imaging. Ieee Transactions on Nuclear Science 2009, 56 (4), 1795-1799.
13. Llopart, X.; Campbell, M.; Dinapoli, R.; Segundo, D. S.; Pemigotti, E., Medipix2: a 64-k pixel readout chip with 55 mu m square elements working in single photon counting mode. Ieee Transactions on Nuclear Science 2002, 49 (5), 2279-2283.
14. Ballabriga, R.; Campbell, M.; Heijne, E. H. M.; Llopart. X.; Tlustos, L., The medipix3 prototype, a pixel readout chip working in single photon counting mode with improved spectrometric performance. Ieee Transactions on Nuclear Science 2007, 54 (5), 1824-1829.
15. Broennimann, C.; Eikenberry, E. F.; Henrich, B.; Horisberger, R.; Huelsen, G.; Pohl, E.; Schmitt, B.; Schulze-Briese, C.; Suzuki, M.; Tomizaki, T.; Toyokawa, H.; Wagner, A., The PILATUS 1M detector. Journal of Synchrotron Radiation 2006, 13, 120-130.
6. Nik. S. J.; Meyer, J.; Watts, R., Optimal material discrimination using spectral x-ray imaging. Physics in Medicine and Biology 2011, 56 (18), 5969-5983.
7. Jakubek, J., Data processing and image reconstruction methods for pixel detectors. Nuclear Instruments & Methods in Physics Research Section α-Accelerators Spectrometers Detectors and Associated Equipment 2007, 576 (1). 223-234.
8. Roessl, E.; Proksa, R., K-edge imaging in x-ray computed tomography using multi-bin photon counting detectors. Physics in Medicine and Biology 2007, 52 (15). 4679-4696.
9. Fredenberg, E.; Lundqvist, M.; Cederstrom, B.; Aslund, M.; Danielsson, M., Energy resolution of a photon-counting silicon strip detector. Nuclear Instruments &Methods in Physics Research Section α-Accelerators Spectrometers Detectors and Associated Equipment 2010, 613 (1), 156-162.
10. Boone, J. M.; Shaber, G. S.; Tecotzky, M., Dual-Energy Mammography—A Detector Analysis

### Medical Physics 1990, 17 (4), 665-675.

11. Butler, A. P. H.; Anderson, N. G.; Tipples, R.; Cook, N.; Watts, R.; Meyer, J.; Bell, A. J.; Melzer, T. R.; Butler, P. H., Bio-medical X-ray imaging with spectroscopic pixel detectors. Nuclear Instruments & Methods in Physics Research Section α-Accelerators Spectrometers Detectors and Associated Equipment 2008, 591 (1), 141-146.
12. Procz, S.; Lubke, J.; Zwerger, A.; Mix, M.; Fiederle, M.; Optimization of Medipix-2 Threshold Masks for Spectroscopic X-Ray Imaging. Ieee Transactions on Nuclear Science 2009, 56 (4), 1795-1799.
13. Llopart, X.; Campbell, M.; Dinapoli, R.; Segundo, D. S.; Pemigotti, E., Medipix2: a 64-k pixel readout chip with 55 mu m square elements working in single photon counting mode. Ieee Transactions on Nuclear Science 2002, 49 (5), 2279-2283.
14. Ballabriga, R.; Campbell, M.; Heijne, E. H. M.; Llopart. X.; Tlustos, L., The medipix3 prototype, a pixel readout chip working in single photon counting mode with improved spectrometric performance. Ieee Transactions on Nuclear Science 2007, 54 (5), 1824-1829.
15. Broennimann, C.; Eikenberry, E. F.; Henrich, B.; Horisberger, R.; Huelsen, G.; Pohl, E.; Schmitt, B.; Schulze-Briese, C.; Suzuki, M.; Tomizaki, T.; Toyokawa, H.; Wagner, A., The PILATUS 1M detector. Journal of Synchrotron Radiation 2006, 13, 120-130.
6. Nik. S. J.; Meyer, J.; Watts, R., Optimal material discrimination using spectral x-ray imaging. Physics in Medicine and Biology 2011, 56 (18), 5969-5983.
7. Jakubek, J., Data processing and image reconstruction methods for pixel detectors. Nuclear Instruments & Methods in Physics Research Section α-Accelerators Spectrometers Detectors and Associated Equipment 2007, 576 (1). 223-234.
8. Roessl, E.; Proksa, R., K-edge imaging in x-ray computed tomography using multi-bin photon counting detectors. Physics in Medicine and Biology 2007, 52 (15). 4679-4696.
9. Fredenberg, E.; Lundqvist, M.; Cederstrom, B.; Aslund, M.; Danielsson, M., Energy resolution of a photon-counting silicon strip detector. Nuclear Instruments & Methods in Physics Research Section α-Accelerators Spectrometers Detectors and Associated Equipment 2010, 613 (1), 156-162.
10. Boone, J. M.; Shaber, G. S.; Tecotzky, M., Dual-Energy Mammography—A Detector Analysis

### Medical Physics 1990, 17 (4), 665-675.

11. Butler, A. P. H.; Anderson, N. G.; Tipples, R.; Cook, N.; Watts, R.; Meyer, J.; Bell, A. J.; Melzer, T. R.; Butler, P. H., Bio-medical X-ray imaging with spectroscopic pixel detectors. Nuclear Instruments & Methods in Physics Research Section α-Accelerators Spectrometers Detectors and Associated Equipment 2008, 591 (1), 141-146.
12. Procz, S.; Lubke, J.; Zwerger, A.; Mix, M.; Fiederle, M.; Optimization of Medipix-2 Threshold Masks for Spectroscopic X-Ray Imaging. Ieee Transactions on Nuclear Science 2009, 56 (4), 1795-1799.
13. Llopart, X.; Campbell, M.; Dinapoli, R.; Segundo, D. S.; Pemigotti, E., Medipix2: a 64-k pixel readout chip with 55 mu m square elements working in single photon counting mode. Ieee Transactions on Nuclear Science 2002, 49 (5), 2279-2283.
14. Ballabriga, R.; Campbell, M.; Heijne, E. H. M.; Llopart. X.; Tlustos, L., The medipix3 prototype, a pixel readout chip working in single photon counting mode with improved spectrometric performance. Ieee Transactions on Nuclear Science 2007, 54 (5), 1824-1829.
15. Broennimann, C.; Eikenberry, E. F.; Henrich, B.; Horisberger, R.; Huelsen, G.; Pohl, E.; Schmitt, B.; Schulze-Briese, C.; Suzuki, M.; Tomizaki, T.; Toyokawa, H.; Wagner, A., The PILATUS 1M detector. Journal of Synchrotron Radiation 2006, 13, 120-130.
6. Nik. S. J.; Meyer, J.; Watts, R., Optimal material discrimination using spectral x-ray imaging. Physics in Medicine and Biology 2011, 56 (18), 5969-5983.
7. Jakubek, J., Data processing and image reconstruction methods for pixel detectors. Nuclear Instruments & Methods in Physics Research Section α-Accelerators Spectrometers Detectors and Associated Equipment 2007, 576 (1). 223-234.
8. Roessl, E.; Proksa, R., K-edge imaging in x-ray computed tomography using multi-bin photon counting detectors. Physics in Medicine and Biology 2007, 52 (15). 4679-4696.
9. Fredenberg, E.; Lundqvist, M.; Cederstrom, B.; Aslund, M.; Danielsson, M., Energy resolution of a photon-counting silicon strip detector. Nuclear Instruments & Methods in Physics Research Section α-Accelerators Spectrometers Detectors and Associated Equipment 2010, 613 (1), 156-162.
10. Boone, J. M.; Shaber, G. S.; Tecotzky, M., Dual-Energy Mammography—A Detector Analysis

### Medical Physics 1990, 17 (4), 665-675.

11. Butler, A. P. H.; Anderson, N. G.; Tipples, R.; Cook, N.; Watts, R.; Meyer, J.; Bell, A. J.; Melzer, T. R.; Butler, P. H., Bio-medical X-ray imaging with spectroscopic pixel detectors. Nuclear Instruments & Methods in Physics Research Section α-Accelerators Spectrometers Detectors and Associated Equipment 2008, 591 (1), 141-146.
12. Procz, S.; Lubke, J.; Zwerger, A.; Mix, M.; Fiederle, M.; Optimization of Medipix-2 Threshold Masks for Spectroscopic X-Ray Imaging. Ieee Transactions on Nuclear Science 2009, 56 (4), 1795-1799.
13. Llopart, X.; Campbell, M.; Dinapoli, R.; Segundo, D. S.; Pemigotti, E., Medipix2: a 64-k pixel readout chip with 55 mu m square elements working in single photon counting mode. Ieee Transactions on Nuclear Science 2002, 49 (5), 2279-2283.
14. Ballabriga, R.; Campbell, M.; Heijne, E. H. M.; Llopart. X.; Tlustos, L., The medipix3 prototype, a pixel readout chip working in single photon counting mode with improved spectrometric performance. Ieee Transactions on Nuclear Science 2007, 54 (5), 1824-1829.
15. Broennimann, C.; Eikenberry, E. F.; Henrich, B.; Horisberger, R.; Huelsen, G.; Pohl, E.; Schmitt, B.; Schulze-Briese, C.; Suzuki, M.; Tomizaki, T.; Toyokawa, H.; Wagner, A., The PILATUS 1M detector. Journal of Synchrotron Radiation 2006, 13, 120-130.
6. Nik. S. J.; Meyer, J.; Watts, R., Optimal material discrimination using spectral x-ray imaging. Physics in Medicine and Biology 2011, 56 (18), 5969-5983.
7. Jakubek, J., Data processing and image reconstruction methods for pixel detectors. Nuclear Instruments & Methods in Physics Research Section α-Accelerators Spectrometers Detectors and Associated Equipment 2007, 576 (1). 223-234.
8. Roessl, E.; Proksa, R., K-edge imaging in x-ray computed tomography using multi-bin photon counting detectors. Physics in Medicine and Biology 2007, 52 (15). 4679-4696.
9. Fredenberg, E.; Lundqvist, M.; Cederstrom, B.; Aslund, M.; Danielsson, M., Energy resolution of a photon-counting silicon strip detector. Nuclear Instruments & Methods in Physics Research Section α-Accelerators Spectrometers Detectors and Associated Equipment 2010, 613 (1), 156-162.
10. Boone, J. M.; Shaber, G. S.; Tecotzky, M., Dual-Energy Mammography—A Detector Analysis

### Medical Physics 1990, 17 (4), 665-675.

11. Butler, A. P. H.; Anderson, N. G.; Tipples, R.; Cook, N.; Watts, R.; Meyer, J.; Bell, A. J.; Melzer, T. R.; Butler, P. H., Bio-medical X-ray imaging with spectroscopic pixel detectors. Nuclear Instruments & Methods in Physics Research Section α-Accelerators Spectrometers Detectors and Associated Equipment 2008, 591 (1), 141-146.
12. Procz, S.; Lubke, J.; Zwerger, A.; Mix, M.; Fiederle, M.; Optimization of Medipix-2 Threshold Masks for Spectroscopic X-Ray Imaging. Ieee Transactions on Nuclear Science 2009, 56 (4), 1795-1799.
13. Llopart, X.; Campbell, M.; Dinapoli, R.; Segundo, D. S.; Pemigotti, E., Medipix2: a 64-k pixel readout chip with 55 mu m square elements working in single photon counting mode. Ieee Transactions on Nuclear Science 2002, 49 (5), 2279-2283.
14. Ballabriga, R.; Campbell, M.; Heijne, E. H. M.; Llopart. X.; Tlustos, L., The medipix3 prototype, a pixel readout chip working in single photon counting mode with improved spectrometric performance. Ieee Transactions on Nuclear Science 2007, 54 (5), 1824-1829.
15. Broennimann, C.; Eikenberry, E. F.; Henrich, B.; Horisberger, R.; Huelsen, G.; Pohl, E.; Schmitt, B.; Schulze-Briese, C.; Suzuki, M.; Tomizaki, T.; Toyokawa, H.; Wagner, A., The PILATUS 1M detector. Journal of Synchrotron Radiation 2006, 13, 120-130.
6. Nik. S. J.; Meyer, J.; Watts, R., Optimal material discrimination using spectral x-ray imaging. Physics in Medicine and Biology 2011, 56 (18), 5969-5983.
7. Jakubek, J., Data processing and image reconstruction methods for pixel detectors. Nuclear Instruments & Methods in Physics Research Section α-Accelerators Spectrometers Detectors and Associated Equipment 2007, 576 (1). 223-234.
8. Roessl, E.; Proksa, R., K-edge imaging in x-ray computed tomography using multi-bin photon counting detectors. Physics in Medicine and Biology 2007, 52 (15). 4679-4696.
9. Fredenberg, E.; Lundqvist, M.; Cederstrom, B.; Asplundh, M.; Danielsson, M., Energy resolution of a photon-counting silicon strip detector. Nuclear Instruments & Methods in Physics Research Section α-Accelerators Spectrometers Detectors and Associated Equipment 2010, 613 (1), 156-162.
10. Boone, J. M.; Shaber, G. S.; Tecotzky, M., Dual-Energy Mammography—A Detector Analysis

### Medical Physics 1990, 17 (4), 665-675.

11. Butler, A. P. H.; Anderson, N. G.; Tipples, R.; Cook, N.; Watts, R.; Meyer, J.; Bell, A. J.; Melzer, T. R.; Butler, P. H., Bio-medical X-ray imaging with spectroscopic pixel detectors. Nuclear Instruments & Methods in Physics Research Section α-Accelerators Spectrometers Detectors and Associated Equipment 2008, 591 (1), 141-146.
12. Procz, S.; Lubke, J.; Zwerger, A.; Mix, M.; Fiederle, M.; Optimization of Medipix-2 Threshold Masks for Spectroscopic X-Ray Imaging. Ieee Transactions on Nuclear Science 2009, 56 (4), 1795-1799.
13. Llopart, X.; Campbell, M.; Dinapoli, R.; Segundo, D. S.; Pemigotti, E., Medipix2: a 64-k pixel readout chip with 55 mu m square elements working in single photon counting mode. Ieee Transactions on Nuclear Science 2002, 49 (5), 2279-2283.
14. Ballabriga, R.; Campbell, M.; Heijne, E. H. M.; Llopart. X.; Tlustos, L., The medipix3 prototype, a pixel readout chip working in single photon counting mode with improved spectrometric performance. Ieee Transactions on Nuclear Science 2007, 54 (5), 1824-1829.
15. Broennimann, C.; Eikenberry, E. F.; Henrich, B.; Horisberger, R.; Huelsen, G.; Pohl, E.; Schmitt, B.; Schulze-Briese, C.; Suzuki, M.; Tomizaki, T.; Toyokawa, H.; Wagner, A., The PILATUS 1M detector. Journal of Synchrotron Radiation 2006, 13, 120-130.
6. Nik. S. J.; Meyer, J.; Watts, R., Optimal material discrimination using spectral x-ray imaging. Physics in Medicine and Biology 2011, 56 (18), 5969-5983.
7. Jakubek, J., Data processing and image reconstruction methods for pixel detectors. Nuclear Instruments & Methods in Physics Research Section α-Accelerators Spectrometers Detectors and Associated Equipment 2007, 576 (1). 223-234.
8. Roessl, E.; Proksa, R., K-edge imaging in x-ray computed tomography using multi-bin photon counting detectors. Physics in Medicine and Biology 2007, 52 (15). 4679-4696.
9. Fredenberg, E.; Lundqvist, M.; Cederstrom, B.; Aslund, M.; Danielsson, M., Energy resolution of a photon-counting silicon strip detector. Nuclear Instruments & Methods in Physics Research Section α-Accelerators Spectrometers Detectors and Associated Equipment 2010, 613 (1), 156-162.
10. Boone, J. M.; Shaber, G. S.; Tecotzky, M., Dual-Energy Mammography—A Detector Analysis

### Medical Physics 1990, 17 (4), 665-675.

11. Butler, A. P. H.; Anderson, N. G.; Tipples, R.; Cook, N.; Watts, R.; Meyer, J.; Bell, A. J.; Melzer, T. R.; Butler, P. H., Bio-medical X-ray imaging with spectroscopic pixel detectors. Nuclear Instruments & Methods in Physics Research Section α-Accelerators Spectrometers Detectors and Associated Equipment 2008, 591 (1), 141-146.
12. Procz, S.; Lubke, J.; Zwerger, A.; Mix, M.; Fiederle, M.; Optimization of Medipix-2 Threshold Masks for Spectroscopic X-Ray Imaging. Ieee Transactions on Nuclear Science 2009, 56 (4), 1795-1799.
13. Llopart, X.; Campbell, M.; Dinapoli, R.; Segundo, D. S.; Pemigotti, E., Medipix2: a 64-k pixel readout chip with 55 mu m square elements working in single photon counting mode. Ieee Transactions on Nuclear Science 2002, 49 (5), 2279-2283.
14. Ballabriga, R.; Campbell, M.; Heijne, E. H. M.; Llopart. X.; Tlustos, L., The medipix3 prototype, a pixel readout chip working in single photon counting mode with improved spectrometric performance. Ieee Transactions on Nuclear Science 2007, 54 (5), 1824-1829.
15. Broennimann, C.; Eikenberry, E. F.; Henrich, B.; Horisberger, R.; Huelsen, G.; Pohl, E.; Schmitt, B.; Schulze-Briese, C.; Suzuki, M.; Tomizaki, T.; Toyokawa, H.; Wagner, A., The PILATUS 1M detector. Journal of Synchrotron Radiation 2006, 13, 120-130.
16. Henrich, B.; Bergamaschi, A.; Broennimann, C.; Dinapoli, R.; Eikenberry, E. F.; Johnson, I.; Kobas, M.; Kraft, P.; Mozzanica, A.; Schmitt, B., PILATUS: A single photon counting pixel detector for X-ray applications. Nuclear Instruments & Methods in Physics Research Section α-Accelerators Spectrometers Detectors and Associated Equipment 2009, 607 (1), 247-249.
17. Llopart, X.; Ballabriga, R.; Campbell, M.; Tlustos, L.; Wong, W., Timepix, a 65k programmable pixel readout chip for arrival time, energy and/or photon counting measurements. Nuclear Instruments & Methods in Physics Research Section α-Accelerators Spectrometers Detectors and Associated Equipment 2007,581 (1-2), 485-494.
18. Kraft, P.; Bergamaschi, A.; Bronnimann, C.; Dinapoli, R.; Eikenberry, E. F.; Graafsma, H.; Henrich, B.; Johnson, I.; Kobas, M.; Mozzanica, A.; Schleputz, C. A.; Schmitt, B., Characterization and Calibration of PILATUS Detectors, Ieee Transactions on Nuclear Science 2009, 56 (3), 758-764.
19. Kissick, D. J.; Muir, R. D.; Simpson, G. J., Statistical Treatment of Photon/Electron Counting: Extending the Linear Dynamic Range from the Dark Count Rate to Saturation. Analytical Chemistry 2010, 82 (24), 10129-10134.
20. Julien, M.; Kadda, M., Detective quantum efficiency model of single-X-ray-photon counting hybrid pixel detectors. Journal of Instrumentation 2012, 7(11), P11028.
21. Trueb, P.; Sobott, B. A.; Schnyder, R.; Loeliger, T.; Schneebeli, M.; Kobas, M.; Rassool, R. P.; Peake, D. J.; Broennimann, C., Improved count rate corrections for highest data quality with PILATUS detectors. Journal of Synchrotron Radiation 2012, 19, 347-351.
22. Mathieson, K.; Passmore, M. S.; Seller, P.; Prydderch, M. L.; O'Shea, V.; Bates, R. L.; Smith, K. M.; Rahman, M., Charge sharing in silicon pixel detectors. Nuclear Instruments & Methods in Physics Research Section α-Acceleralors Spectrometers Detectors and Associated Equipment 2002, 487 (1-2), 113-122.
23. Springer, M.; Thompson, W., The distribution of products of independent random variables. SIAM Journal on Applied Mathematics 1966, 14 (3), 511-526.
24. Coldwell, R. L.; Lasche, G. P.; Jadczyk, A., Fractional counts—The simulation of low probability events. In Application of Accelerators in Research and Industry, Duggan, J. L.; Morgan, I. L., Eds. 2001; Vol. 576. pp 587-590.
25. Burrell, Q.; Rousseau, R., Fractional Counts for Authorship Attribution—A Numerical Study. Journal of the American Society for Information Science 1995, 46 (2), 97-102.
26. Leydesdorff, L.; Zhou, P.; Bornmann, L., How can journal impact factors be normalized across fields of science? An assessment in terms of percentile ranks and fractional counts. Journal of the American Society for Information Science and Technology 2013, 64 (1), 96-107.
27. Fraser, G. W.; Abbey, A. F.; Holland, A.; McCarthy, K.; Owens, A.; Wells, A.; The X-Ray-Energy Response of Silicon A Theory. Nuclear Instruments & Methods in Physics Research Section α-Accelerators Spectrometers Detectors and Associated Equipment 1994, 350 (1-2), 368-378.
28. Wong, W. In Design considerations for area-constrained in-pixel photon counting in Medipix3. Topical workshop on Electronics for Particle Physics, 2008: pp 539-543.

1. A method for achieving dynamic range detection in X-ray image processing, the method comprising:
acquiring a sensor response based on a plurality of X-ray photons from a sensor, the sensor response comprising a plurality of counts, wherein each count of the plurality of counts comprises an X-ray photon induced transient voltage that exceeds a local set of predetermined voltages;
modeling a peak height distribution, using a functional form, for a plurality of single photon responses from a histogram of the X-ray photon induced transient voltage;
calculating a second peak height distribution for a plurality of simultaneous photons based on the plurality of single photon response and the peak height distribution;
performing Poisson weighting on the peak height distribution and the second peak height distribution, thereby generating a Poisson weighted peak height distribution;
determining a number of photons using the Poisson weighted peak height distribution; and
forming an image based on the determined number of photons at each pixel location of the sensor.

2. The method of claim 1, wherein the sensor comprises a pixel array detector, wherein the pixel array detector comprises a plurality of X-ray photon counting electronics at the each pixel location.

3. The method of claim 1, herein a global set of predetermined voltages comprises the local set of predetermined voltages.

4. The method of claim 3, wherein each predetermined voltage of the global set of predetermined voltages are adjustable.

5. The method of claim 1, wherein each predetermined voltage of the local set of predetermined voltages are adjustable.

6. The method of claim 1, wherein the peak height distribution is used to determine energy of each X-ray photon of the plurality of X-ray photons.

8. A method for achieving dynamic range detection in X-ray image processing, the method comprising:
acquiring a sensor response based on a plurality of X-ray photons from a sensor, the sensor response comprising a plurality of counts, wherein each count of the plurality of counts comprises an X-ray photon induced transient voltage that exceeds a local set of predetermined voltages;
determining a point spread function from the plurality of counts;
modeling a fractional peak height distribution from the point spread function and a size of a single pixel of the sensor;
determining a fractional number of photons from the point spread function and the size of the single pixel of the sensor; and
forming an image based on the determined number of photons at each pixel location of the sensor.

9. The method of claim 8, wherein the determining the point spread function from the plurality of counts comprises determining the point spread function for a charged plume from the plurality of counts, wherein the charged plume is produced by the sensor when the plurality of X-ray photons is absorbed by the sensor.

10. The method of claim 8, wherein a global set of predetermined voltages comprises the local set of predetermined voltages.

11. A non-transitory computer-readable medium encoded with a computer-readable program which, when executed by a processor, will cause a computer to execute a method, the method comprising:
acquiring a sensor response based on a plurality of X-ray photons from a sensor, the sensor response comprising a plurality of counts, wherein each count of the plurality of counts comprises an X-ray photon induced transient voltage that exceeds a local set of predetermined voltages;
modeling a peak height distribution, using a functional form, for a plurality of single photon responses from a histogram of the X-ray photon induced transient voltage;
calculating a second peak height distribution for a plurality of simultaneous photons based on the plurality of single photon response and the peak height distribution;
performing Poisson weighting on the peak height distribution and the second peak height distribution, thereby generating a Poisson weighted peak height distribution;
determining a number of photons using the Poisson weighted peak height distribution; and
forming an image based on the determined number of photons at each pixel location of the sensor.

12. The method of claim 11, wherein the sensor comprises a pixel array detector, wherein the pixel array detector comprises a plurality of X-ray photon counting electronics at the each pixel location.

13. The method of claim 11, wherein a global set of predetermined voltages comprises the local set of predetermined voltages.

14. The method of claim 13, wherein each predetermined voltage of the global set of predetermined voltages are adjustable.

15. The method of claim 11, wherein each predetermined voltage of the local set of predetermined voltages are adjustable.

16. The method of claim 1, wherein the peak height distribution is used to determine energy of each X-ray photon of the plurality of X-ray photons.
